(19) United States
(12) Patent Application Publication
(10) Pub. No.: US 2015/0261385 A1
(43) Pub. Date: Sep. 17, 2015

(54) PICTURE SIGNAL OUTPUT APPARATUS, PICTURE SIGNAL OUTPUT METHOD, PROGRAM, AND DISPLAY SYSTEM

(71) Applicant: Seiko Epson Corporation, Tokyo (JP)

(72) Inventors: Mitsunori Tomono, Shimosuwa-machi (JP); Makoto Shigemitsu, Sapporo-shi (JP)

(21) Appl. No.: 14/638,320

(22) Filed: Mar. 4, 2015

(30) Foreign Application Priority Data
Mar. 17, 2014 (JP) 2014-053671

(51) Int. Cl. G06F 3/042; G06F 3/01; G06F 3/048

(52) U.S. Cl. CPC G06F 3/0425; G06F 3/048; G06F 3/017

(57) ABSTRACT

A function of reflecting an operation performed using a pointing element with respect to an image displayed by a display device without a function of recognizing the position of the pointing element on the image is realized. A projector as a display device displays an image corresponding to picture signals output from a portable terminal on a screen. A camera as an imaging unit of the portable terminal captures an image of the screen with a finger. The portable terminal detects a trajectory of the finger on the screen based on the captured image. The portable terminal generates an image corresponding to the detected trajectory, synthesizes the generated image and an image corresponding to image data, and generates a synthetic image. The portable terminal outputs picture signals corresponding to the generated synthetic image to the projector.

### CROSS-REFERENCE TO RELATED APPLICATION

The entire disclosure of Japanese Patent Application No. 2014-053671, filed Mar. 17, 2014 is expressly incorporated by reference herein.

### BACKGROUND

1. Technical Field

The present invention relates to a technology of displaying images.

2. Related Art

A technology of recognizing a position of a pointing element such as a hand or finger on a display screen of a display device and reflecting the position on the display screen has been known. For example, Patent Document 1 (JP-A-2011-203830) discloses that the position of a hand of a user is detected from an image captured by a camera mounted on a projector as a display device and reflected on a displayed image based on the detected position of the hand. Patent Document 2 (JP-A-2011-180712) discloses that the position of a hand is recognized from an image captured by a camera mounted on a projector and the finger of a user and its shadow are detected, and thereby, based on the distance between the user's finger and its shadow, whether or not the finger is in contact with a screen is determined and reflected on a displayed image.

In related art as disclosed in Patent Document 1 or 2, it is necessary for the display device to mount a camera, recognize the position of the pointing element such as the hand or finger of the user, and reflect the position on the displayed image. Therefore, there have been problems that the configuration of the display device becomes complex and, the display device with higher processing capability is required, and the cost becomes higher.

### SUMMARY

An advantage of some aspects of the invention is to implement a function of reflecting an operation performed using a pointing element such as a hand or finger with respect to an image displayed by a display device with respect to the image even when a display device without a function of recognizing the position of the pointing element is used.

A picture signal output apparatus according to an aspect of the invention includes an output unit that outputs picture signals corresponding to a first image to a display device, an imaging unit that captures both an image of a display screen displayed by the display device based on the picture signals output by the output unit and a pointing element, a detection unit that detects a trajectory of the pointing element as a trajectory of the pointing element on the display screen based on the captured image, a generation unit that generates a second image corresponding to the detected trajectory, and a synthesizing unit that forms a synthetic image by synthesizing the generated second image and the first image, wherein the output unit outputs picture signals corresponding to the generated synthetic image to the display device.

According to the picture signal output apparatus, a function of reflecting an operation performed using a pointing element with respect to an image displayed by a display device on the image may be realized even when a display device without a function of recognizing the position of the pointing element is used.

The picture signal output apparatus may further includes a recognition unit that recognizes a shape of the pointing element based on the captured image, wherein the generation unit controls generation of the second image in response to the shape of the pointing element recognized by the recognition unit.

According to the picture signal output apparatus, whether or not to reflect the user's operation on the image may be controlled by the shape of the pointing element.

The picture signal output apparatus may further includes a recognition unit that recognizes a shape of the pointing element based on the captured image, wherein the second image is a line drawing corresponding to the trajectory, and the generation unit changes a line used in the line drawing in response to the shape of the pointing element recognized by the recognition unit.

According to the picture signal output apparatus, the line of the second image may be changed by the shape of the pointing element.

The pointing element may be a hand or finger. In this case, it is not necessary to prepare a special pointing element.

The picture signal output apparatus may be a portable terminal. In this case, it is not necessary to make special settings because the portable terminal may be easily carried anywhere.

The display device may be a projector. In this case, projection on a large screen is easier and the user may perform operation on the large screen.

A picture signal output method according to an aspect of the invention includes (A) capturing both an image of a display screen on which a first image is displayed by a display device and a pointing element, (B) detecting a trajectory of the pointing element as a trajectory of the pointing element on the display screen based on the captured image, (C) generating a second image corresponding to the detected trajectory, and (D) forming a synthetic image by synthesizing the generated second image and the first image, and (E) outputting picture signals corresponding to the generated synthetic image to the display device.

According to the picture signal output method, a function of reflecting an operation performed using a pointing element with respect to an image displayed by a display device on the image may be realized even when a display device without a function of recognizing the position of the pointing element is used.

The picture signal output method described above may be implemented as a program allowing a computer to execute the above described steps.

According to the program, a function of reflecting an operation performed using a pointing element with respect to an image displayed by a display device on the image may be realized even when a display device without a function of recognizing the position of the pointing element is used.

A display system according to an aspect of the invention includes a picture signal output apparatus that outputs picture signals corresponding to a first image, a display device that displays an image corresponding to the picture signals on a display screen, and an imaging device that captures an image of the display screen with a pointing element, wherein the picture signal output apparatus includes a detection unit that detects a trajectory of the pointing element as a trajectory of the pointing element on the display screen based on the captured image, a generation unit that generates a second image corresponding to the detected trajectory, a synthesizing unit that forms a synthetic image by synthesizing the generated second image and the first image, and an output unit that outputs picture signals corresponding to the generated synthetic image to the display device.

According to the display system, a function of reflecting an operation performed using a pointing element with respect to an image displayed by a display device on the image may be realized even when a display device without a function of recognizing the position of the pointing element is used.

### BRIEF DESCRIPTION OF THE DRAWINGS

The invention will be described with reference to the accompanying drawings, wherein like numbers reference like elements.

FIG. 1 shows a hardware configuration of a display system.

FIG. 2 shows a hardware configuration of a projector.

FIG. 3 shows a hardware configuration of a portable terminal.

FIG. 4 shows a functional configuration of the portable terminal.

FIG. 5 is a flowchart showing projection processing performed by the display system.

FIG. 6 is a flowchart showing interactive processing.

FIG. 7 shows examples of hand shapes used for user's operations.

FIG. 8 shows an example of generation of a handwritten image.

FIG. 9 shows an example of a synthetic image.

FIG. 10 shows an example of the synthetic image displayed on a screen.

FIG. 11 shows examples of hand shapes used for user's operations according to a modified example.

FIG. 12 shows examples of hand shapes used for user's operations according to a modified example.

FIG. 13 shows examples of hand shapes used for user's operations according to a modified example.

### DESCRIPTION OF EXEMPLARY EMBODIMENTS

### 1. Configuration

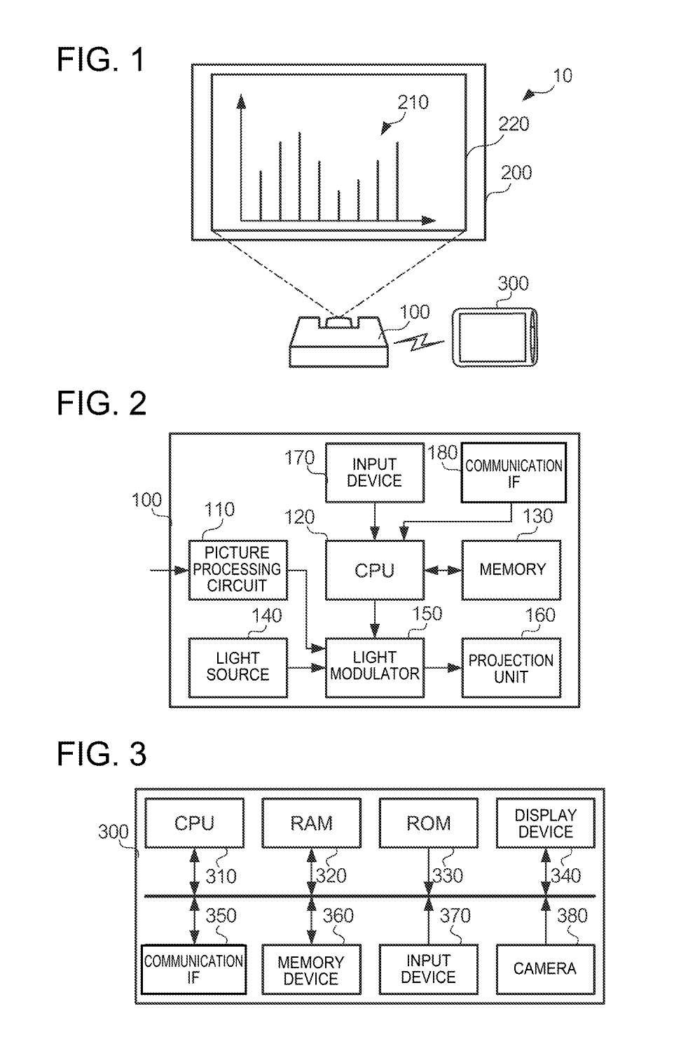

FIG. 1 shows a hardware configuration of a display system 10. The display system 10 is a system of displaying image on a display screen. Further, the display system 10 realizes a function of reflecting an operation performed using a finger as a pointing element with respect to an image displayed on the display screen on the image. The display system 10 includes a projector 100 as a display device, a screen 200, and a portable terminal 300. The screen 200 is an example of projection surface (display screen). Both the projector 100 and the portable terminal 300 are provided to be directed toward the screen 200. The projector 100 and the portable terminal 300 are in wireless or wired connection. Here, the projector 100 and the portable terminal 300 are wirelessly connected.

FIG. 2 shows a hardware configuration of the projector 100. The projector 100 is a device that projects images on the screen 200. The projector 100 has a picture processing circuit 110, a CPU (Central Processing Unit) 120, a memory 130, a light source 140, a light modulator 150, a projection unit 160, an input device 170, and a communication IF (interface) unit 180.

The picture processing circuit 110 performs video processing on picture signals and outputs the video-processed signals to the light modulator 150. The CPU 120 is a control device that controls other hardware of the projector 100. The memory 130 is a memory device that stores a program and various kinds of data. The light source 140 is a device that outputs projection light and includes a light emitting device such as a lamp or laser and a drive circuit therefor. The light modulator 150 is a device that modulates the light output from the light source 140 in response to the signal output from the picture processing circuit 110, and includes a liquid crystal panel or an electrooptical device such as a DMD (Digital Mirror Device) and a drive circuit therefor. The projection unit 160 is a device of projecting the light modulated by the light modulator 150 on the screen 200, and includes an optical system of a dichroic prism, a projection lens, a focus lens, etc. The input device 170 is a device used by the user to input instructions or information to the projector 100 (CPU 120), and includes e.g., a keypad, touch screen, or remote controller. The communication IF unit 180 is an interface that communicates with the portable terminal 300.

FIG. 3 shows a hardware configuration of the portable terminal 300. The portable terminal 300 is e.g., a smartphone. The portable terminal 300 is an example of the picture signal output apparatus. Further, when an operation is performed using a finger on the image displayed on the screen 200, the portable terminal 300 performs processing for reflecting the operation on the image. The portable terminal 300 has a CPU 310, a RAM (Random Access Memory) 320, a ROM (Read Only Memory) 330, a display device 340, a communication IF 350, a memory device 360, an input device 370, and a camera 380 as an imaging unit or imaging device.

The CPU 310 is a control device that controls other hardware of the portable terminal 300. The RAM 320 is a volatile memory device that functions as a work area when the CPU 310 executes the program. The ROM 330 is a nonvolatile memory device that stores the data and the program. The display device 340 is a device that displays information, e.g., a liquid crystal display. The communication IF 350 is an interface that communicates with the projector 100. The memory device 360 is a rewritable nonvolatile memory device that stores the data and the program. The input device 370 is a device to input information in response to the user's operation to the CPU 310, and includes e.g., a keyboard, mouse, or touch screen. The camera captures 380 images. The above described elements are connected by a bus.

In the memory device 360, image data 361 to be output to the projector 100 is stored. The image data 361 may represent e.g., images used as materials for a presentation or video such as movies.

Further, in the memory device 360, a drawing application 363 is stored. The drawing application 363 basically converts the image data 361 stored in the memory device 360 into picture signal suitable for processing of the projector 100 and transmits the signals to the projector 100. For example, when the projector 100 supports a predetermined frame rate, the drawing application 363 converts the image data 361 into picture signals at the predetermined frame rate and transmits the signals.

Note that, when an operation is performed using a finger with respect to the image displayed on the screen 200, the drawing application 363 transmits picture signals corresponding to the images reflecting the operation to the projector 100. For example, when an operation of writing information by hand is performed on the screen 200, the drawing application 363 transmits picture signals corresponding to an image formed by synthesizing the image represented by the image data 361 stored in the memory device 360 and the information written by hand to the projector 100. The picture signals also have the format suitable for the processing of the projector 100 like the picture signals corresponding to the above described image data 361.

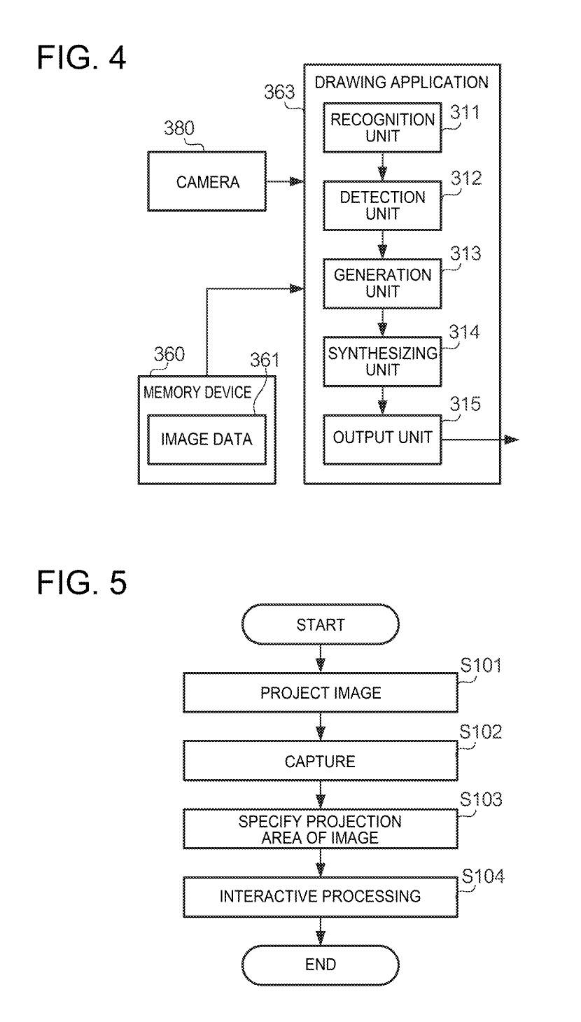

FIG. 4 shows a functional configuration of the portable terminal 300. The CPU 310 executes the drawing application 363, and thereby, the portable terminal 300 realizes functions of a recognition unit 311, a detection unit 312, a generation unit 313, a synthesizing unit 314, and an output unit 315. The portable terminal 300 is an example of a computer that realizes these functions. The functions may be realized in cooperation between the CPU 310 and another hardware configuration.

The output unit 315 outputs the picture signals corresponding to the image data 361 stored in the memory device 360. The projector 100 projects a first image corresponding to the picture signals output from the output unit 315 on the screen 200. The camera 380 takes an image of the screen 200. The recognition unit 311 recognizes the hand shape based on the image taken by the camera 380. The detection unit 312 detects the trajectory of the finger on the screen 200 based on the image taken by the camera 380. The generation unit 313 generates a second image in response to the trajectory detected by the detection unit 312. The synthesizing unit 314 generates a synthetic image 250 by synthesizing the second image generated by the generation unit 313 and the first image corresponding to the image data 361 stored in the memory device 360. The output unit 315 outputs picture signals corresponding to the synthetic image 250 to the projector 100.

### 2. Performance

FIG. 5 is a flowchart showing projection processing performed by the display system 10. At step 5101, when the picture signals corresponding to the image data 361 is output from the portable terminal 300, the projector 100 projects an image 210 corresponding to the picture signals on the screen 200. The image 210 is an example of the image on the display screen. Specifically, by the output unit 315 of the portable terminal 300, the picture signals corresponding to the image data 361 stored in the memory device 360 (first image) are transmitted to the projector 100. When receiving the picture signals, the projector 100 projects the image 210 corresponding to the received picture signals on the screen 200.

Thereby, as shown in FIG. 1, the image 210 is displayed on the screen 200. Note that, as described above, the portable terminal 300 and the projector 100 are wirelessly connected, and the picture signals are wirelessly transmitted.

At step S102, the camera 380 of the portable terminal 300 takes a video of a range containing the screen 200. The video includes a plurality of images continuously taken. These images are sequentially output.

At step S103, the detection unit 312 specifies a projection area 220 of the image 210 on the screen 200 based on the images output from the camera 380. For example, the detection unit 312 compares the images output from the camera 380 and the image 210 represented by the image data 361 and specifies apart with the higher correlation as the projection area 220.

At step S104, the portable terminal 300 performs interactive processing.

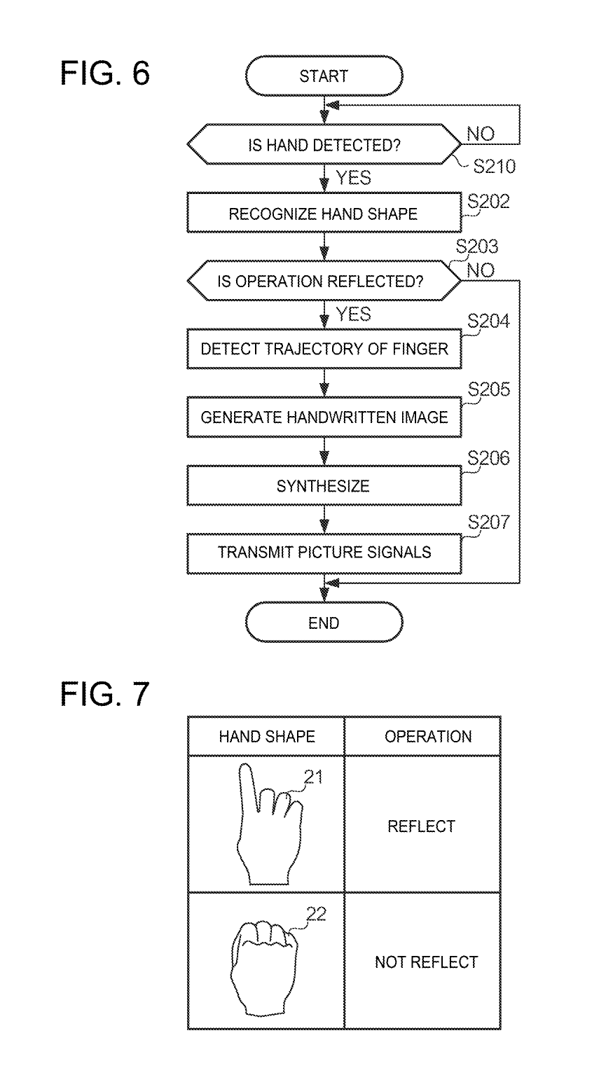

FIG. 6 is a flowchart showing the interactive processing. At step S201, the detection unit 312 detects the hand of the user from the projection area 220 specified at step S103 based on the image output from the camera 380. For example, when the projection area 220 of the image output from the camera 380 contains apart having a feature of the hand, the detection unit 312 detects the part as the hand. The feature is e.g., a color and shape. If the hand is detected from the projection area 220 (step S201: YES), the interactive processing moves to step S202. On the other hand, if the hand is not detected from the projection area 220 (step S201: NO), the processing at step S201 is performed based on the next image output from the camera 380.

At step S202, the recognition unit 311 recognizes the hand shape detected at step S201. For example, the recognition unit 311 recognizes the hand shape by matching the detected part of the hand and various hand shape patterns.

At step S203, the generation unit 313 determines whether or not to reflect the user's operation on the image 210 in response to the hand shape recognized at step S202.

FIG. 7 shows examples of hand shapes used for user's operations. In the examples shown in FIG. 7, the hand shape 21 or 22 is used for the user's operation. The shape 21 is a shape with a single finger held up. The shape 22 is a shape with all five fingers folded. In the examples shown in FIG. 7, if the shape 21 is recognized at step S202, the generation unit 313 determines to reflect the user's operation on the image 210. In this case, the interactive processing moves to step S204. On the other hand, if the shape 22 is recognized at step S202, the generation unit 313 determines not to reflect the user's operation on the image 210. In this case, the interactive processing returns to step S201.

At step S204, the detection unit 312 detects the trajectory of the finger as the finger trajectory on the projection area 220 based on the image output from the camera 380. Specifically, the detection unit 312 calculates coordinates indicating the position of the finger tip on the projection area 220 in each image output from the camera 380. In this regard, it is not necessary that the finger tip is in contact with the screen 200. As long as the coordinates indicating the position of the finger tip on the projection area 220 may be calculated based on the image output from the camera 380, the finger tip may be separated from the screen 200. The detection unit 312 detects the line connecting the calculated coordinates along the time sequence as the finger trajectory. Further, the detection unit 312 sets a virtual screen in response to the image data 361 stored in the memory device 360, and projection-converts the projection area 220 on the virtual screen. The virtual screen corresponds to the image data 361, and has the same aspect ratio as that of the image data 361, for example. Thereby, the coordinates indicating the trajectory of the finger tip on the projection area 220 are converted into coordinates of the coordinate system of the virtual screen.

At step S205, the generation unit 313 generates the handwritten image 240 corresponding to the trajectory detected at step S204. The handwritten image 240 is an example of the second image.

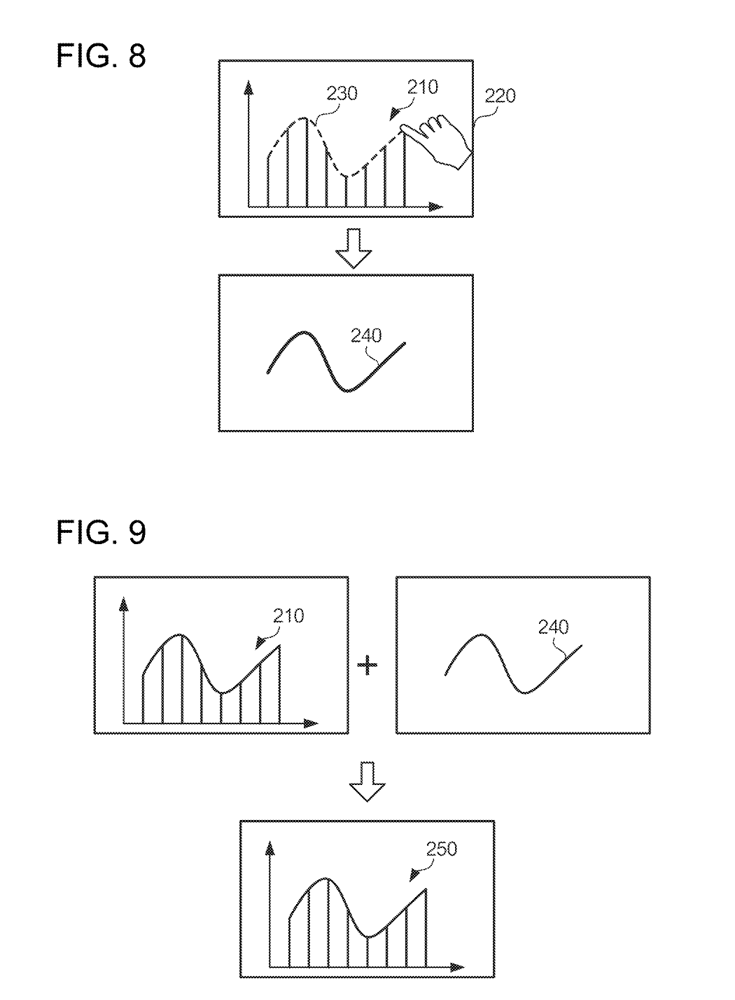

FIG. 8 shows an example of generation of the handwritten image 240. In the example shown in FIG. 8, the user draws a line 230 with a finger on the image 210 displayed on the screen 200. In this case, the line drawing representing the line 230 is generated as the handwritten image 240.

Note that, if a determination that the user's operation is reflected on the image 210 is made at the above described step S203, the generation unit 313 generates the handwritten image 240, however, if a determination that the user's operation is not reflected on the image 210 is made, the unit does not generate the handwritten image 240. The determination is made in response to the hand shape recognized at step S202. In this manner, the generation unit 313 controls generation of the handwritten image 240 in response to the hand shape recognized at step S202. Further, the determination may be made depending on whether or not a hand or finger is in contact with the screen 200. Whether or not there is contact may be determined utilizing the shadow of the hand or finger.

At step S206, the synthesizing unit 314 generates the synthetic image 250 by synthesizing the handwritten image 240 generated at step S205 and the image 210 represented by the image data 361 stored in the memory device 360. In this regard, the synthesizing unit 314 aligns and synthesizes the handwritten image 240 and the image 210 so that the handwritten image 240 may be placed in the position indicated by the coordinates based on the coordinates of the trajectory on the virtual screen.

FIG. 9 shows an example of generation of the synthetic image 250. In the example shown in FIG. 9, the synthetic image 250 is generated by superimposing the handwritten image 240 on the image 210.

At step S207, the output unit 315 transmits the picture signals corresponding to the synthetic image 250 generated at step S206 to the projector 100.

When receiving the picture signals corresponding to the synthetic image 250, the projector 100 projects the synthetic image 250 corresponding to the received picture signals on the screen 200. Thereby, the synthetic image 250 is displayed on the screen 200.

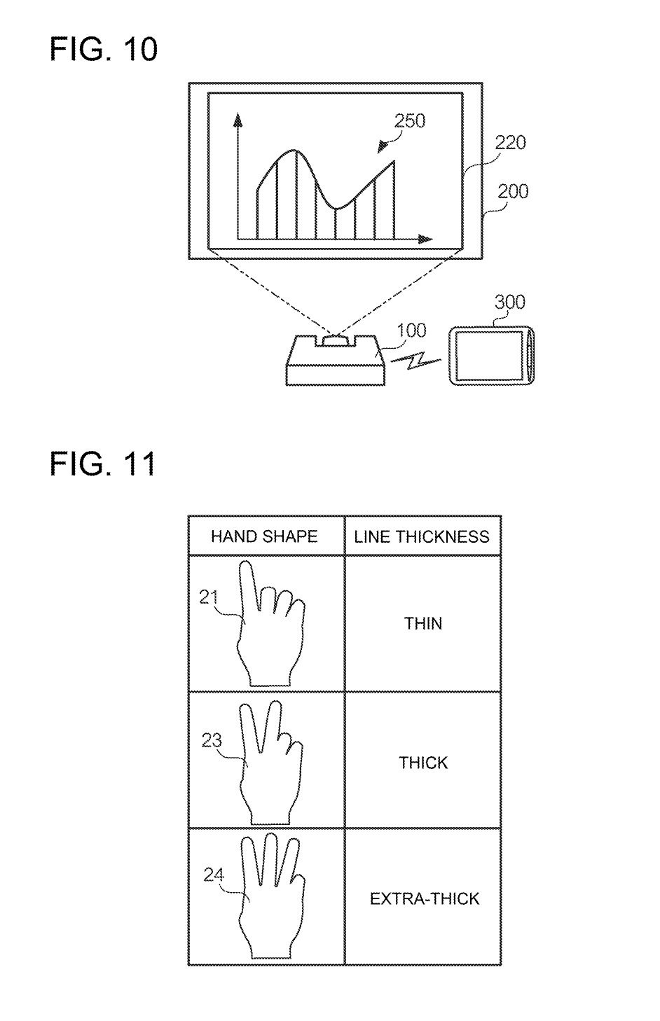

FIG. 10 shows an example of the synthetic image 250 displayed on the screen 200. The synthetic image 250 contains the handwritten image 240 representing the line 230 drawn by the finger of the user. In this manner, the user may write information by handwriting with respect to the image 210 displayed on the screen 200.

While the information written by hand by the user is displayed on the screen 200, the picture signals corresponding to the synthetic image 250 are output from the portable terminal 300 to the projector 100. On the other hand, while the information written by hand by the user is not displayed on the screen 200, the picture signals corresponding to the image data 361 are output from the portable terminal 300 to the projector 100.

Further, display and non-display of the information written by the user may be switched at the following times: (1) when an operation of inputting a switch instruction is performed using the input device 370 of the portable terminal 300; (2) when the operation of inputting the switch instruction is performed on the screen 200; and (3) in the case where the image data as a base for the image displayed on the screen 200 by the projector 100 is image data segmented in a plurality of pages, when the page of the image displayed on the screen 200 is changed.

For example, in the case of (2), when an image formed by synthesizing the image 210 represented by the image data 361 and a menu image for switch operation is projected on the screen 200 and an operation of selecting the menu image is performed on the screen 200, display and non-display of the information written by the user (e.g., the handwritten image 240) may be switched. Further, for example, in the case of (3), when the page of the image displayed on the screen 200 is changed, the information written by the user during the display of the image of the previous page (e.g., the handwritten image 240) may be erased.

In the embodiment, the interactive processing is performed utilizing the portable terminal 300, and thereby, it is not necessary for the projector 100 to include a dedicated device such as an infrared camera. Therefore, the function of reflecting the operation performed by the finger with respect to the image 210 projected by the projector 100 on the image 210 using the projector 100 having the simple configuration without the function of recognizing the position of the pointing element, for example can be realized.

Further, in related art, when information is written by hand with respect to the image displayed on the screen 200, for example, it is necessary that the image formed by synthesizing an icon indicating the operation of instructing drawing is displayed on the screen 200 and the user performs an operation of selecting the icon on the screen 200. However, in the embodiment, only by forming the hand shape in the shape 21 shown in FIG. 7 without the operation, information may be written by hand with respect to the image 210 displayed on the screen 200.

Furthermore, in the embodiment, if the hand shape is formed in the shape 21 shown in FIG. 7, even when the line 230 is drawn with a finger floating from the screen 200, for example, the handwritten image 240 is generated. Accordingly, the user is not necessarily required to contact the screen 200 when performing the operation of writing information by hand with respect to the image 210 displayed on the screen 200. Thereby, deterioration and damage of the screen 200 may be suppressed.

### 3. Modified Examples

The invention is not limited to the above described embodiment, however, various modifications may be made. As below, some modified examples will be explained. Two or more of the following modified examples may be combined and used.

In the above described embodiment, the generation unit 313 may change the thickness of the line used in the handwritten image 240 in response to the hand shape recognized at step S202.

FIG. 11 shows examples of hand shapes used for user's operations according to the modified example. In the examples shown in FIG. 11, a hand shape 21, 23, or 24 is used for user's operation. As described above, the shape 21 is the shape with the single finger held up. The shape 23 is a shape with two fingers held up. The shape 24 is a shape with three fingers held up. In this case, at step S203, if the shape 21, 23, or 24 is recognized at step S202, a determination that the user's operation is reflected on the image 210 is made. At step S205, if the shape 21 is recognized at step S202, the handwritten image 240 is generated using a thin line. If the shape 23 is recognized at step S202, the handwritten image 240 is generated using a thick line. If the shape 24 is recognized at step S202, the handwritten image 240 is generated using an extra-thick line.

In the above described embodiment, the generation unit 313 may change the type of the line used in the handwritten image 240 in response to the hand shape recognized at step S202.

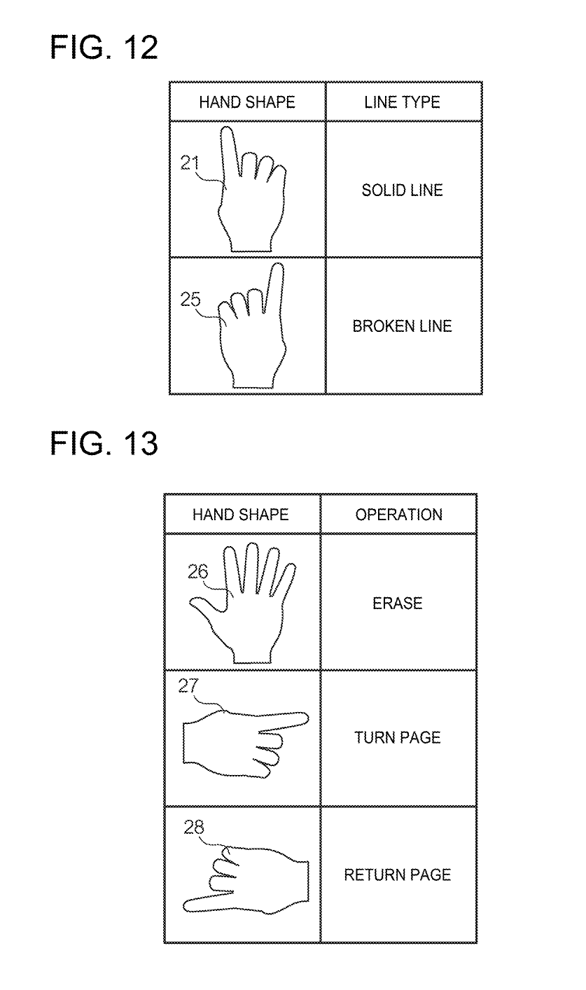

FIG. 12 shows examples of hand shapes used for user's operations according to the modified example. In the examples shown in FIG. 12, a hand shape 21 or 25 is used for user's operation. The shape 21 is a right-hand shape with a single finger held up. The shape 25 is a left-hand shape with a single finger held up. In this case, at step S203, if the shape 21 or 25 is recognized at step S202, a determination that the user's operation is reflected on the image 210 is made. At step S205, if the shape 21 is recognized at step S202, the handwritten image 240 is generated using a solid line. If the shape 25 is recognized at step S202, the handwritten image 240 is generated using a broken line.

In the above described embodiment, the portable terminal 300 may change the image 210 or the synthetic image 250 displayed on the screen 200 in response to the shape of the finger(s) recognized at step S202.

FIG. 13 shows examples of hand shapes used for user's operations according to the modified example. In the examples shown in FIG. 13, a hand shape 26, 27, or 28 is used for user's operation. The shape 26 is a shape with five fingers held up. The shape 27 is a shape with a single finger held up and pointing to the right of the user. The shape 28 is a shape with a single finger held up and pointing to the left of the user.

In the examples shown in FIG. 13, the shape 26 is used for an operation of erasing the handwritten image 240. For example, when desiring to erase the handwritten image 240 part contained in the synthetic image 250 shown in FIG. 10, the user forms the hand shape in the shape 26 and lays the hand on the part of the handwritten image 240 contained in the synthetic image 250 displayed on the screen 200. In this case, if the shape 26 is recognized at step S202, the portable terminal 300 generates an image formed by erasing the handwritten image 240 part from the synthetic image 250, and transmits picture signals corresponding to the generated image to the projector 100. In this regard, the portable terminal 300 may erase only the part corresponding to the position of the hand of the user of the handwritten image 240 part or erase all of the handwritten image 240 part. When receiving the picture signals, the projector 100 projects an image corresponding to the received picture signals on the screen 200. Thereby, the image from which the handwritten image 240 has been erased is displayed on the screen 200.

In the examples shown in FIG. 13, the shape 27 is used for an operation of turning the page of the images displayed on the screen 200. In this case, image data segmented in a plurality of pages is stored in the memory device 360. If the shape 27 is recognized at step S202, the output unit 315 reads out the image data of the next page from the memory device 360 and transmits picture signals corresponding to the image data to the projector 100. For example, when the image on the tenth page is displayed on the screen 200, picture signals corresponding to the image data of the 11th page are transmitted to the projector 100. When receiving the picture signals, the projector 100 projects an image of the next page corresponding to the received picture signals on the screen 200. Thereby, the image of the next page is displayed on the screen 200.

In the examples shown in FIG. 13, the shape 28 is used for an operation of returning the page of the images displayed on the screen 200. In this case, image data segmented in a plurality of pages is stored in the memory device 360. If the shape 28 is recognized at step S202, the output unit 315 reads out the image data of the previous page from the memory device 360 and transmits picture signals corresponding to the image data to the projector 100. For example, when the image on the tenth page is displayed on the screen 200, picture signals corresponding to the image data of the ninth page are transmitted to the projector 100. When receiving the picture signals, the projector 100 projects an image of the previous page corresponding to the received picture signals on the screen 200. Thereby, the image of the previous page is displayed on the screen 200.

The hand shapes explained in the above described embodiment and modified examples are just examples. The above described operations may be performed using other shapes. Further, the hand shapes used for the above described operations may be set with respect to each user. Furthermore, the hand shapes used for the above described operations may be stored in the portable terminal 300 in advance or stored in an external device and downloaded to the portable terminal 300. The external device may be e.g., a cloud server device that delivers service utilizing cloud computing.

In the above described embodiment, for example, when the portable terminal 300 is not provided to be directed toward the screen 200, the projection area 220 is not specified at step S103. In this case, the portable terminal 300 may display a message of “direct toward screen 200” on the display device 340.

In the above described embodiment, in order to facilitate recognition of the hand shape, the user may perform operations with a special finger cot or glove. Further, the user may perform operations using a pointing element such as a pen or rod. The pointing element is not required to have a function of emitting infrared light. In this case, the detection unit 312 recognizes the shape and the position of the pointing element such as a pen, and a rod based on the image output from the camera 380.

In the above described embodiment, the function of the portable terminal 300 may be realized by a plurality of applications. For example, the recognition unit 311, the detection unit 312, the generation unit 313 and the synthesizing unit 314, and the output unit 315 shown in FIG. 4 may be realized by different applications.

In the above described embodiment, the image data 361 may be stored in an external device. The external device may be another portable terminal or a cloud server device that delivers service utilizing cloud computing. In this case, the external device and the portable terminal 300 are in wireless or wired connection. The portable terminal 300 acquires the image data 361 from the external device and performs the processing explained in the embodiment. In the modified example, the external device functions as a memory device.

In the above described embodiment, in place of the portable terminal 300, an external device may perform part or all of the processing explained in the embodiment. The external device may be another portable terminal or a cloud server device that delivers service utilizing cloud computing. In this case, the external device has at least part of the functions shown in FIG. 4. When the external device has all of the functions shown in FIG. 4, the external device functions as an output device. On the other hand, when external device has part of the functions shown in FIG. 4, the portable terminal 300 and the external device function as an output device in cooperation with each other.

For example, the external device may store the image data 361 and has the function of the synthesizing unit 314. In this case, the external device and the portable terminal 300 are in wireless or wired connection. The portable terminal 300 transmits the image data representing the handwritten image 240 generated by the generation unit 313 to the external device. When receiving the image data, the external device generates the synthetic image 250 based on the received image data. The external device transmits synthetic image data representing the synthetic image 250 to the portable terminal 300. When receiving the synthetic image data from the external device, the portable terminal 300 transmits picture signals corresponding to the received synthetic image data to the projector 100. Alternatively, the external device may transmit picture signals corresponding to the synthetic image 250 to the projector 100. As another example, the projector 100 may include the camera 380 and further has all of the functions shown in FIG. 4.

The sequence of the processing performed by the portable terminal 300 is not limited to the sequence explained in the embodiment. For example, the processing at step S103 shown in FIG. 5 may be performed before the processing at step S210 of the interactive processing shown in FIG. 6.

The above described portable terminal 300 is not limited to the smartphone. For example, the portable terminal 300 may be a notebook personal computer, tablet computer, or digital camera.

The above described display device is not limited to the projector 100. For example, a non-projection type display device such as a liquid crystal display, an organic EL (Electro Luminescence) display, a plasma display may be employed.

The program executed by the CPU 310 may be stored in a computer-readable recording medium such as a magnetic recording medium (magnetic tape, magnetic disk (HDD, FD (Flexible Disk), or the like), an optical recording medium (optical disk (CD (Compact Disk), DVD (Digital Versatile Disk)) or the like), a magneto-optical recording medium, or a semiconductor memory (flash ROM or the like) to be provided. Further, the program may be downloaded via a network such as the Internet.

What is claimed is:

1. A picture signal output apparatus comprising:
an output unit that outputs picture signals corresponding to a first image to a display device;
an imaging unit that captures both an image of a display screen displayed by the display device based on the picture signals output by the output unit and a pointing element;
a detection unit that detects a trajectory of the pointing element as a trajectory of the pointing element on the display screen based on the captured image;
a generation unit that generates a second image corresponding to the detected trajectory; and
a synthesizing unit that forms a synthetic image by synthesizing the generated second image and the first image,
wherein the output unit outputs picture signals corresponding to the generated synthetic image to the display device.

2. The picture signal output apparatus according to claim 1, further comprising a recognition unit that recognizes a shape of the pointing element based on the captured image,
wherein the generation unit controls generation of the second image in response to the shape of the pointing element recognized by the recognition unit.

3. The picture signal output apparatus according to claim 1, further comprising a recognition unit that recognizes a shape of the pointing element based on the captured image,
wherein the second image is a line drawing corresponding to the trajectory, and
the generation unit changes a line used in the line drawing in response to the shape of the pointing element recognized by the recognition unit.

4. The picture signal output apparatus according to claim 1, wherein the pointing element is a hand or a finger.

5. The picture signal output apparatus according to claim 1, being a portable terminal.

6. The picture signal output apparatus according to claim 1, wherein the display device is a projector.

7. A picture signal output method comprising:
(A) capturing both an image of a display screen on which a first image is displayed by a display device and a pointing element;
(B) detecting a trajectory of the pointing element as a trajectory of the pointing element on the display screen based on the captured image;
(C) generating a second image corresponding to the detected trajectory; and
(D) forming a synthetic image by synthesizing the generated second image and the first image; and
(E) outputting picture signals corresponding to the generated synthetic image to the display device.

8. The picture signal output method according to claim 7, wherein the step (B) further includes recognizing a shape of the pointing element based on the image captured at the step (A), and
the step (C) controls generation of the second image in response to the recognized shape of the pointing element.

9. The picture signal output method according to claim 7, wherein the step (B) further includes recognizing a shape of the pointing element based on the image captured at the step (A),
the second image is a line drawing corresponding to the trajectory, and
the step (C) changes a line used in the line drawing in response to the recognized shape of the pointing element.

10. The picture signal output method according to claim 7, wherein the pointing element is a hand or a finger.

11. A display system comprising:
a picture signal output apparatus that outputs picture signals corresponding to a first image;
a display device that displays an image corresponding to the picture signals on a display screen; and
an imaging device that captures an image of the display screen with a pointing element,
wherein the picture signal output apparatus includes
a detection unit that detects a trajectory of the pointing element as a trajectory of the pointing element on the display screen based on the captured image,
a generation unit that generates a second image corresponding to the detected trajectory,
a synthesizing unit that forms a synthetic image by synthesizing the generated second image and the first image, and
an output unit that outputs picture signals corresponding to the generated synthetic image to the display device.
